(19) United States
(12) Patent Application Publication
(10) Pub. No.: US 2008/0209535 A1
(43) Pub. Date: Aug. 28, 2008

(54) Configuration of mandatory access control security policies

(75) Inventors: James L. Athey, Washington, DC (US); Karl W. MacMillan, Silver Spring, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Tresys Technology, LLC, Columbia, MD (US)

(21) Appl. No.: 11/711,853

(22) Filed: Feb. 28, 2007

(51) Int. Cl. G06F 15/16

(52) U.S. Cl. 726/11

(57) ABSTRACT

Presented herein are systems and methods for configuring a mandatory access control security policy in a computer, and applications thereof. An embodiment provides a security configuration program. The security configuration program configures a security policy based on user input. For example, a user may provide input regarding ranges of values corresponding to a resource, such as ports and/or Internet protocol (IP) addresses, to which a process is to be granted access. The security configuration program configures the security policy to allow the process access to the specified ranges of values for the resource. In this way, a security configuration program in accordance with an embodiment of the present invention allows a user to configure and extend a security policy without special knowledge of the security policy language.

### FIELD OF THE INVENTION

The present invention is generally directed to computer security. More particularly, it is directed to configuring mandatory access control in a computer, and applications thereof.

### BACKGROUND OF THE INVENTION

Many computer operating systems have a security mechanism commonly referred to as access control. There are two main types of access control—discretionary access control and mandatory access control.

Under discretionary access control, system resources have security attributes (e.g., read/write/execute permission flags and/or access control lists) associated with them. Access to system resources is controlled based on these security attributes, which are used to protect the system resources (e.g., files) owned by one user from unauthorized access by other users. A weakness associated with discretionary access control is that the security attributes assigned to each system resource are specified by the resource owner and can be modified or removed at will. During a computer attack, an attacker may be able to alter discretionary access control security attributes and thereby gain access to any or all system resources.

Under mandatory access control, access to system resources is controlled by security attributes that cannot be modified or removed during normal operation. In this way, mandatory access control offers a greater level of security compared to discretionary access control.

One form of mandatory access control is type enforcement. Type enforcement is implemented, for example, in security-enhanced Linux (SELinux). In type enforcement, both applications and system resources are assigned type labels. Access for a type enforcement system such as SELinux is defined by a collection of rules contained in a file called a policy. A policy file is loaded into the operating system of a machine during the boot process. The type labels assigned to applications and system resources cannot be changed during normal operation.

Although mandatory access control such as type enforcement provides a greater level of security than discretionary access control, configuring the policy is difficult. The policy language of SELinux, for example, exposes many complexities of the operating system that must be well understood by a system developer before the system developer can create an effective security-enhanced system. Many system developers, however, do not have such an understanding. Therefore, many system developers cannot take advantage of the enhanced security offered by mandatory access control such as type enforcement.

What are needed are new techniques and tools for configuring mandatory access control that overcome the deficiencies noted above.

### BRIEF SUMMARY OF THE INVENTION

The present invention provides systems and methods for configuring a mandatory access control security policy in a computer, and applications thereof. In an embodiment, the present invention provides a security configuration program. The security configuration program configures a security policy based on user input. For example, a user may provide input regarding ranges of values corresponding to a resource, such as ports and/or Internet protocol (IP) addresses, to which a process is to be granted access. The security configuration program configures the security policy to allow the process access to the specified ranges of values for the resource. In this way, a security configuration program in accordance with an embodiment of the present invention allows a user to configure and extend a security policy without special knowledge of the security policy language.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a diagram illustrating a machine that includes a security configuration program.

FIGS. 2A-B illustrate screen shots of an example graphical user interface that may be used to manage port ranges to which a security policy grants processes access.

FIG. 3 is a diagram illustrating a portion of the security policy corresponding to the port ranges illustrated in FIGS. 2A-B.

FIG. 4 illustrates a process being added to the machine of FIG. 1.

FIG. 5 illustrates a relationship between screen shots of an example graphical user interface that may be used to reconfigure port ranges to which the security policy grants processes access.

FIG. 6 is a diagram illustrating an embodiment of the security configuration program included on the machine of FIG. 1.

FIG. 7 is a diagram illustrating how a range sifter module generates non-overlapping ranges of ports.

FIG. 8 is a diagram illustrating how an attribute grouping module generates type and attribute definitions based on the non-overlapping ranges of ports of FIG. 7.

FIG. 9 is a diagram illustrating how a labeling module generates labeling statements based on the non-overlapping ranges of FIG. 7.

FIG. 10 is a diagram illustrating how a linking module generates a policy binary based on the type and attribute definitions of FIG. 7, the labeling statements of FIG. 8, and access rules included in a security policy.

FIGS. 11A-B illustrate screen shots of an example graphical user interface that may be used to manage IP address ranges to which the security policy grants processes access.

FIG. 12 is a diagram illustrating a portion of the security policy corresponding to the IP address ranges illustrated in FIGS. 11A-B.

FIG. 13 illustrates a screen shot of an example graphical user interface that may be used to reconfigure IP address ranges to which the security policy grants processes access.

FIG. 14 is a diagram illustrating how a range sifter module generates non-overlapping ranges of IP addresses.

FIG. 15 is a diagram illustrating how an attribute grouping module generates type and attribute definitions based on a portion of the non-overlapping ranges of IP addresses of FIG. 14.

FIG. 16 is a diagram illustrating how a labeling module generates labeling statements based on a portion of the non-overlapping ranges of IP addresses of FIG. 14.

FIG. 17 is a diagram illustrating a linking module that generates policy binary based on the type and attribute definitions of FIG. 15, the labeling statements of FIG. 16, and access rules included in a security policy.

FIG. 18 is a diagram of an example computer system.

The features and advantages of the present invention will become more apparent from the detailed description set forth below when read in conjunction with the drawings. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The present invention provides systems and methods for configuring a mandatory access control security policy in a computer, and applications thereof. In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

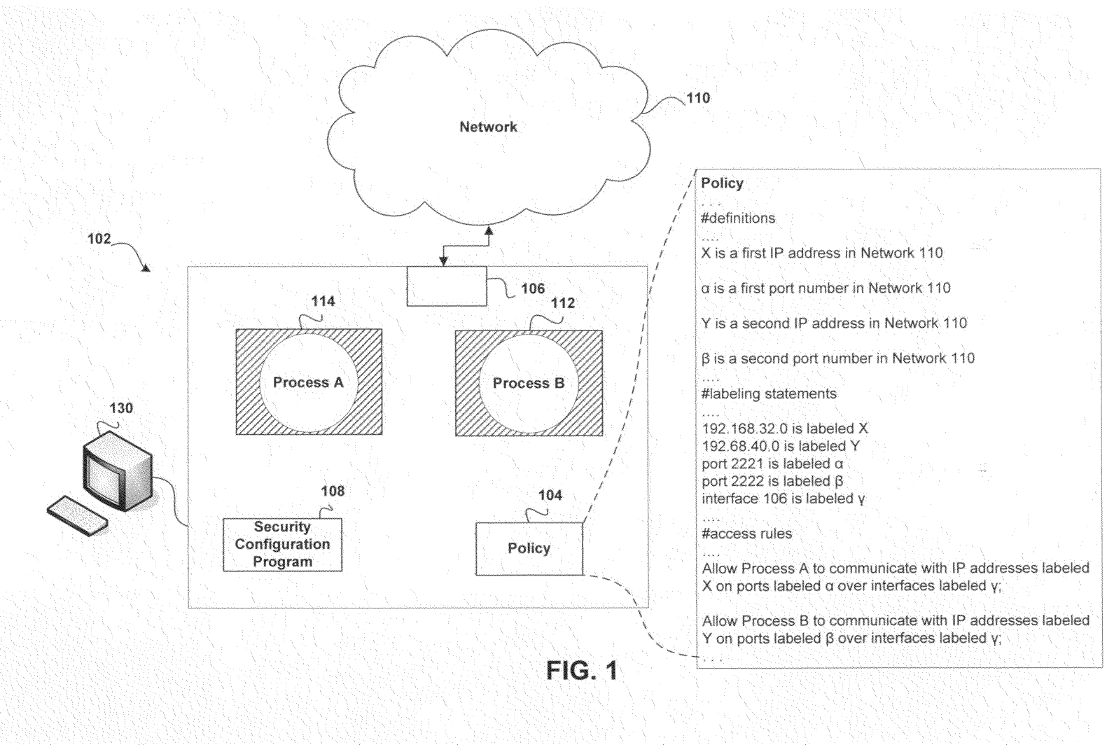

FIG. 1 illustrates a machine 102 coupled to a network 110 according to an embodiment of the present invention. Machine 102 includes a process A, a process B, a policy 104, and a security configuration program 108 that allows a user to manage and configure policy 104. Policy 104 provides security 114 for process A and security 112 for process B.

As illustrated in FIG. 1, policy 104 includes definitions, labeling statements, and access rules. The definitions define types used by the policy. These types are associated via labeling statements to resources available on machine 102 (such as ports, IP addresses, network interfaces, and files). For example, X is declared as a first IP address in network 110, and alpha (a) is declared as a first port number in network 110. Similarly, Y is declared as a second IP address in network 110, and beta (β) is declared as a second port number in network 110.

The labeling statements label the types of resources according to the specific value(s) of the resource. For example, as illustrated in policy 104 of FIG. 1, IP address 192.168.32.0 is labeled X and IP address 192.68.40.0 is labeled Y. Port 2221 is labeled alpha (α), and port 2222 is labeled beta (β). Network interface 106 (which may comprise an ethernet card, for example) is labeled gamma (γ).

The access rules grant access to the resources based on attributes. For example, the access rules of policy 104 allow process A to communicate with IP addresses labeled X over ports labeled alpha (α) over interfaces labeled gamma (γ) on machine 102. Similarly, the access rules of policy 104 allow process B to communicate with IP addresses labeled Y on ports labeled beta (β) over interfaces labeled gamma (γ).

As mentioned above, security configuration program 108 allows a user to manage and/or configure policy 104 running on machine 102. A user may utilize features and tools of security configuration program 108 by interacting with a graphical user interface provided on a display 130.

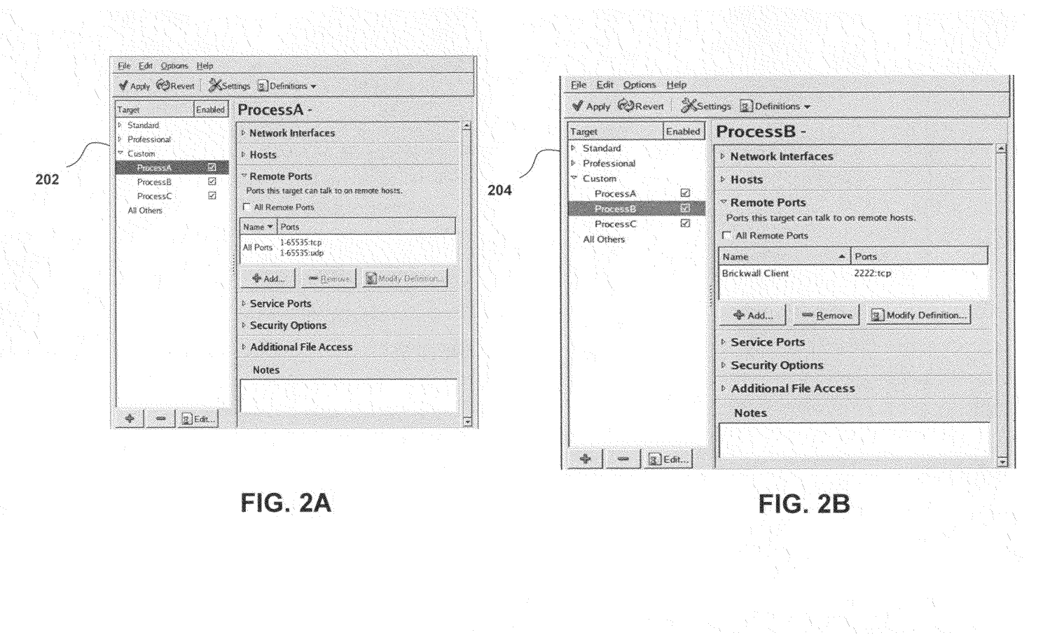

For example, FIGS. 2A-B illustrate a first graphical user interface screen shot 202 and a second graphical user interface screen shot 204 that the user may interact with to manage security policy 104. Screen shot 202 illustrates ranges of ports with which process A may communicate, as currently specified by security policy 104. Screen shot 202 illustrates that process A may communicate with all Transmission Control Protocol (TCP) ports and all User Datagram Protocol (UDP) ports. That is, screen shot 202 illustrates that security policy 104, as currently configured, allows process A to communication with TCP ports 1 through 65,535 and UDP ports 1 through 65,535.

Screen shot 204 illustrates ranges of ports with which process B may communicate, as currently specified by security policy 104. Screen shot 204 illustrates that the current configuration of security policy 104 only allows process B to communicate with TCP port 2222.

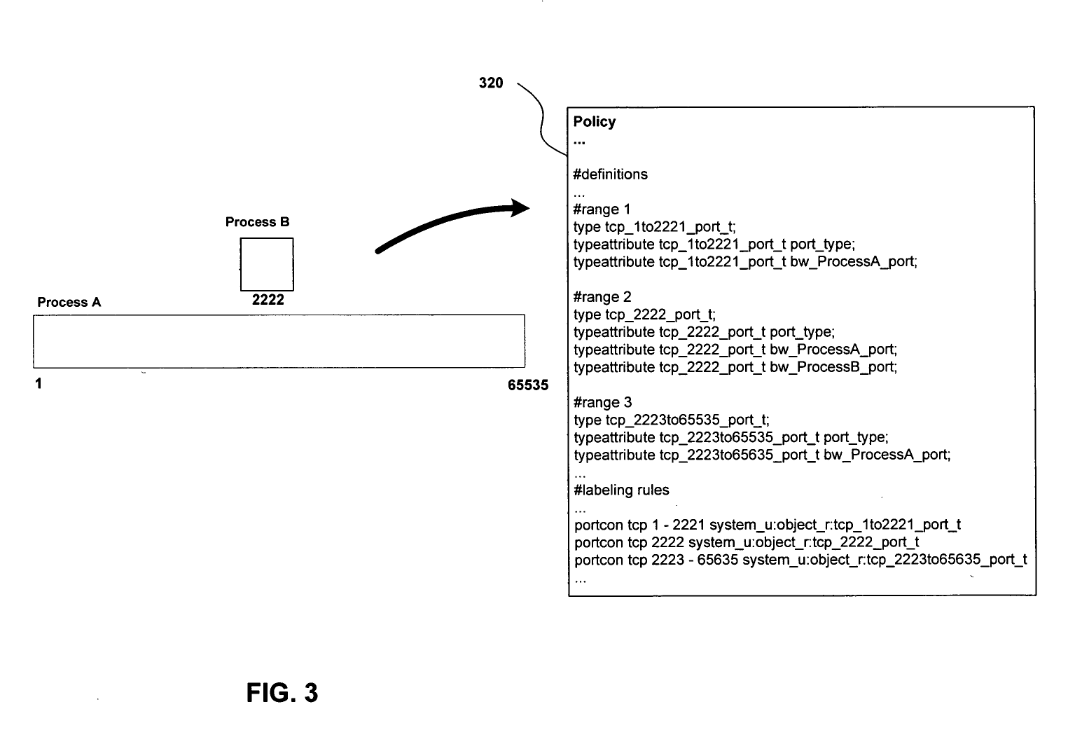

FIG. 3 illustrates a portion of a security policy 320 corresponding to the port ranges with which process A may communicate and the port ranges with which process B may communicate. Security policy 320 is an example security policy implemented in SELinux. SELinux is described in more detail, for example, in Bill McCarty, SELinux: NSA's Open Source Security Enhanced Linux (Andy Oram ed., 2005), and Frank Mayer et al., SELinux by Example (Prentice Hall, 2007), both of which are incorporated by reference herein.

Policy 320 includes definitions and labeling rules. The definitions include three ranges of ports, labeled range 1, range 2, and range 3 in policy 320.

Range 1 is defined as a type that includes ports 1 through 2221, and it is given two attributes. First, it is defined as a port type. Second, it is defined as a port for process A. This is because, according to the example of FIG. 2, only process A is allowed to communicate on ports in the range of 1 to 2221.

Range 2 is defined as a type that includes port 2222, and it is given three attributes. Similar to range 1, range 2 is defined as a port type. Unlike range 1, however, range 2 is defined as a port for both process A and process B. This is because, according to the example of FIG. 2, both process A and process B can communicate on port 2222.

Range 3 is defined as a type that includes ports 2223 through 65535, and it is given similar attributes as range 1. This is because, according to the example of FIG. 2, only process A can communicate on ranges 1 and 3.

The labeling rules included in policy 320 associate the types defined in the definitions with their corresponding resources on machine 102.

As described herein, security configuration program 108 allows a user to manage security policy 104 by interacting with a simple graphical user interface, without requiring the user to understand the complexities of the definitions, labeling statements, and access rules of security policy 104.

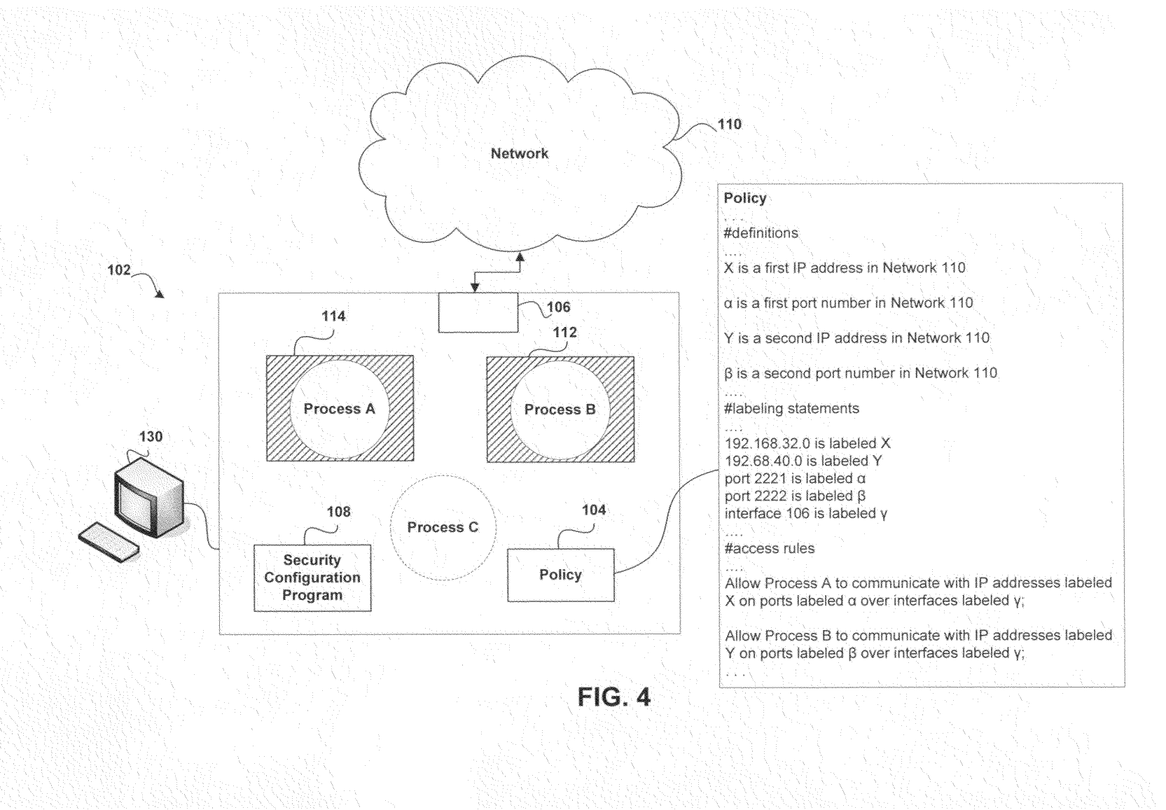

FIG. 4 illustrates the implementation of a new process C on machine 102. As described herein, security configuration program 108 allows a user to reconfigure security policy 104 to accommodate new process C. For example, if new process C is included on machine 102, as illustrated in FIG. 4, security configuration program 108 allows a user to specify a range of values of a resource (such as ports and/or IP addresses) to which process C should be granted access. Based on the range of values provided by the user, security configuration program 108 automatically reconfigures security policy 104 to provide security for process C. In this way, the user does not have to understand the complexities of writing a security policy in order to reconfigure or customize security policy 104. In an embodiment, security configuration program 108 may even be adapted to reconfigure security policy 104 without requiring a reboot of machine 102.

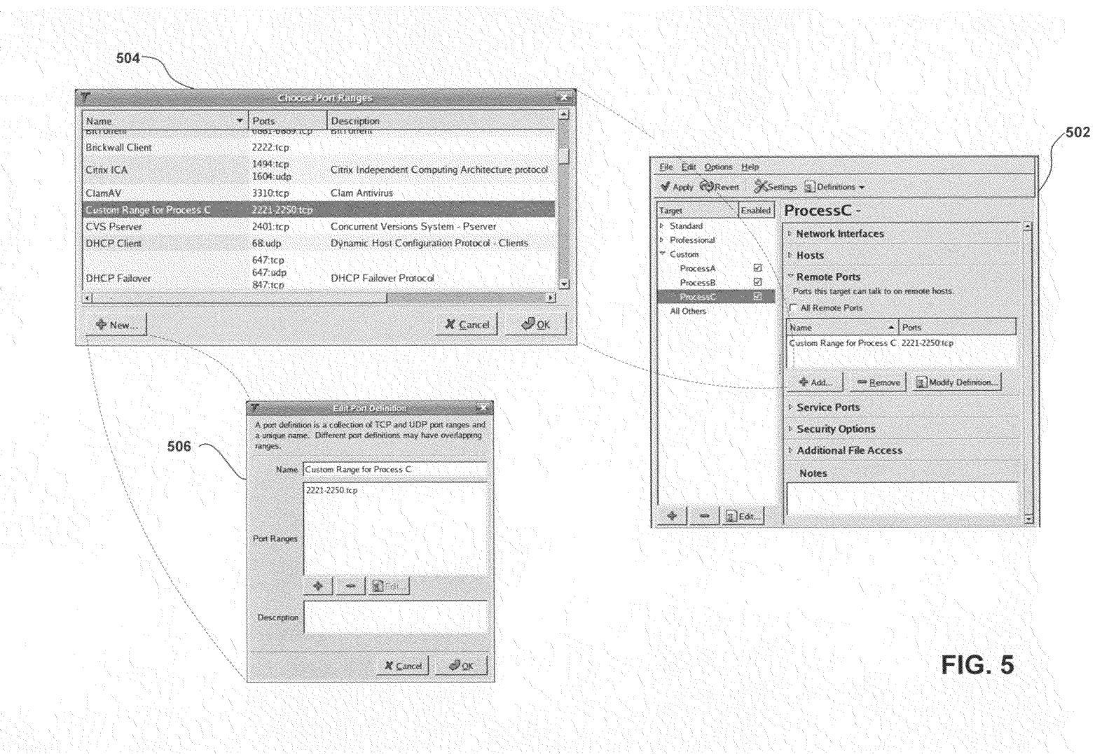

FIG. 5 illustrates the relationship between screen shots of an example of graphical user interface with which a user may specify port ranges to which a target (such as process C) should be granted access. A user may select the target from a list or may create a new range. For example, the user may click on the “ADD” button shown in screen shot 502 to bring up a box 504. From box 504, the user may select a range from a list. If the user wants to add a new target, the user may click the “NEW” button on box 504 to bring up a box 506. In box 506, the user may enter the name of the new range (e.g., “Custom Range for process C”) and the port ranges to which the target should be granted access (e.g., “2221-2225:tcp”). Based on the port ranges and target specified by the user (e.g., TCP ports 2221 through 2225 and process C), security configuration program 108 reconfigures security policy 104.

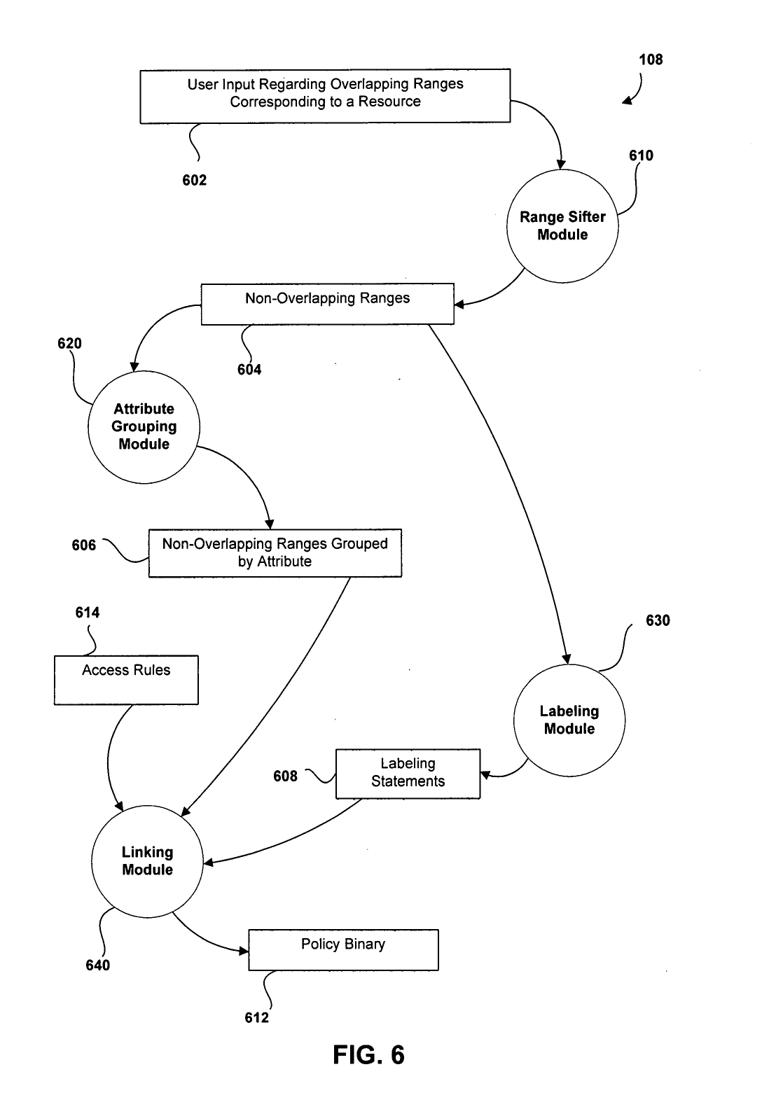

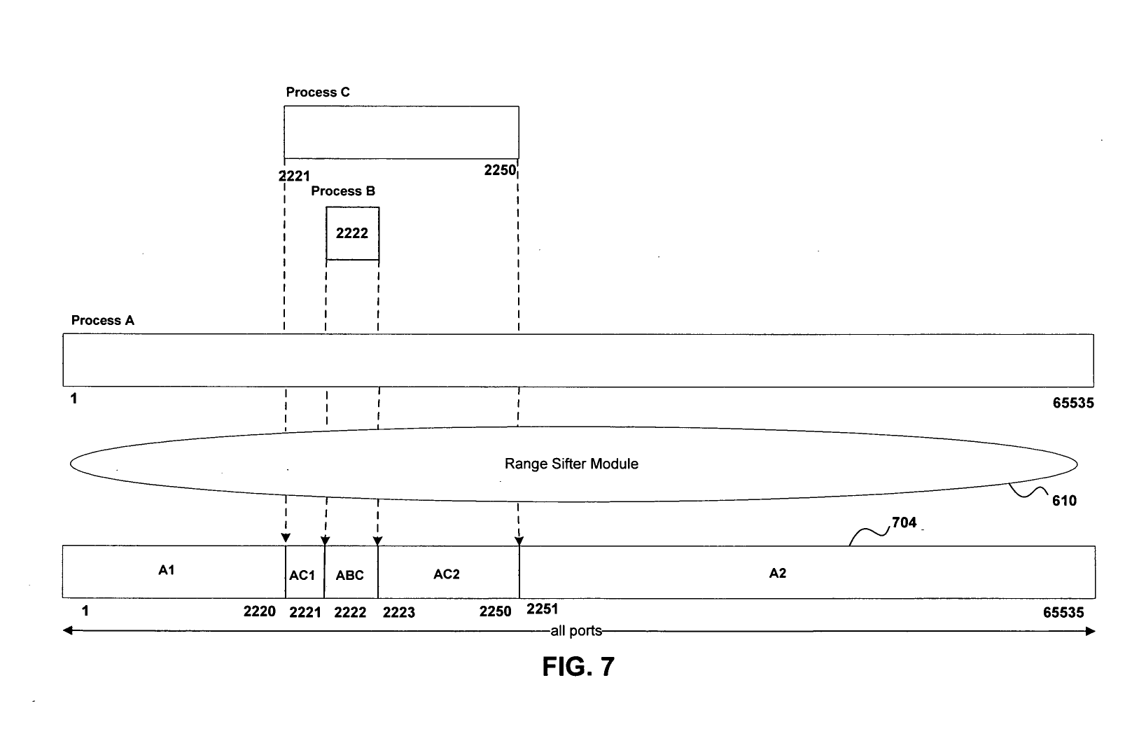

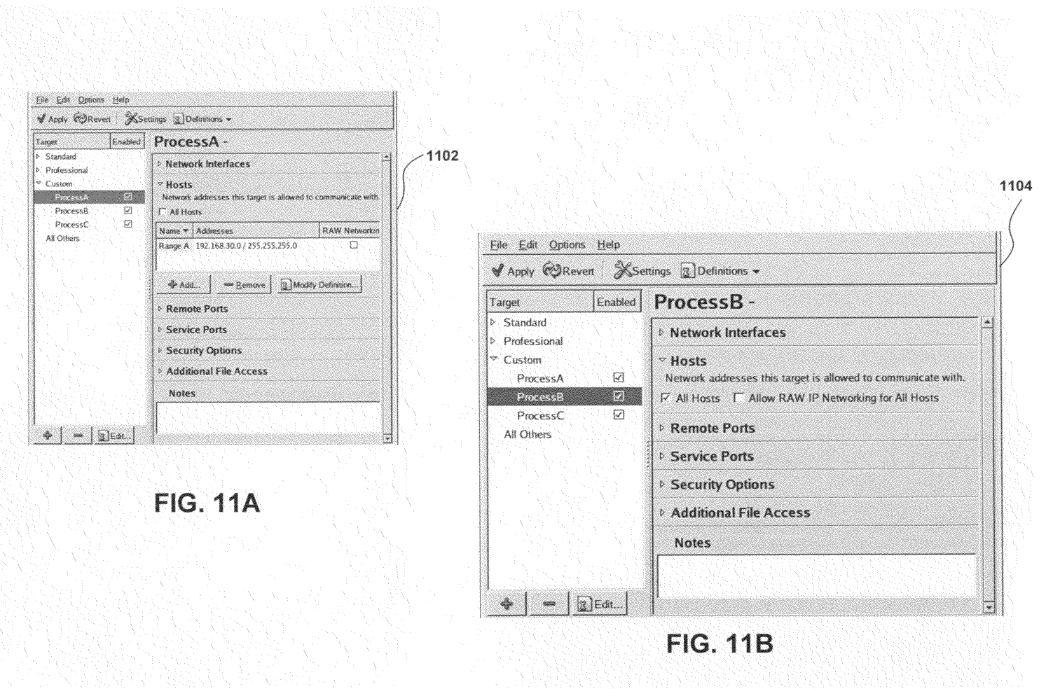

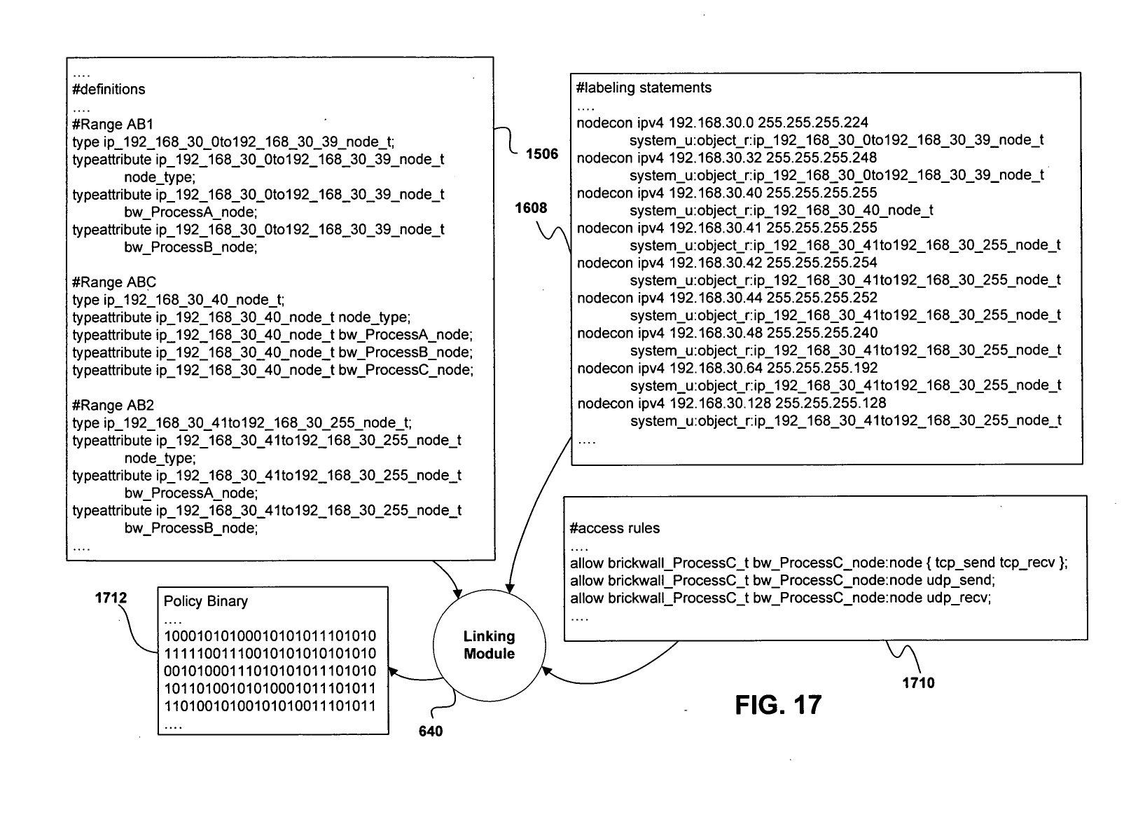

FIG. 6 illustrates an embodiment of security configuration program 108. Based on user input 602 regarding overlapping ranges corresponding to a resource, security configuration program 108 can generate policy binary 612. User input 602 may specify, for example, ranges of ports (as described in more detail below with reference to FIGS. 7-10) or ranges of IP addresses (as described in more detail below with reference to FIGS. 11-17). It is to be appreciated, however, that the examples presented below are for illustrative purposes only, and not limitation. User input 602 may specify other ranges of values corresponding to a resource, such as files, for example.

As illustrated in FIG. 6, security configuration program 108 includes a range sifter module 610, an attribute grouping module 620, a labeling module 630, and optionally includes a linking module 640. Range sifter module 610 generates non-overlapping ranges 604 based on user input 602. Attribute grouping module 620 groups the non-overlapping ranges 604 generated by range sifter module 610 to generate non-overlapping ranges 606. Labeling module 630 generates labeling statements based on non-overlapping ranges 606. Optionally, linking module 640 generates a policy binary 612 based on access rule 614 of the security policy, the non-overlapping ranges 606, and the labeling statement 608 generated by labeling module 630. Each of these modules is described in more detail below.

Range sifter module 610 receives user input 602. Based on user input 602, range sifter module 610 generates non-overlapping ranges 604. For example, as illustrated in FIG. 7, range sifter module 610 may generate non-overlapping ranges 704 corresponding to the user input ranges shown in screen shots 202 and 204 (see FIGS. 2A-B) and screen shot 502 (see FIG. 5). The example user input from FIGS. 2A-B and 5 includes overlapping ranges. Specifically, process A may communicate on ports 1 through 65,535, process B may communicate only on port 2222, and process C may communicate on ports 2221 through 2250. Based on these ranges, range sifter module 610 generates five non-overlapping ranges 704: (1) a range A1 including ports 1 through 2220; (2) a range AC1 including port 2221; (3) a range ABC including port 2222; (4) a range AC2 including ports 2223 through 2250; and (5) a range A2 including ports 2251 through 65,535.

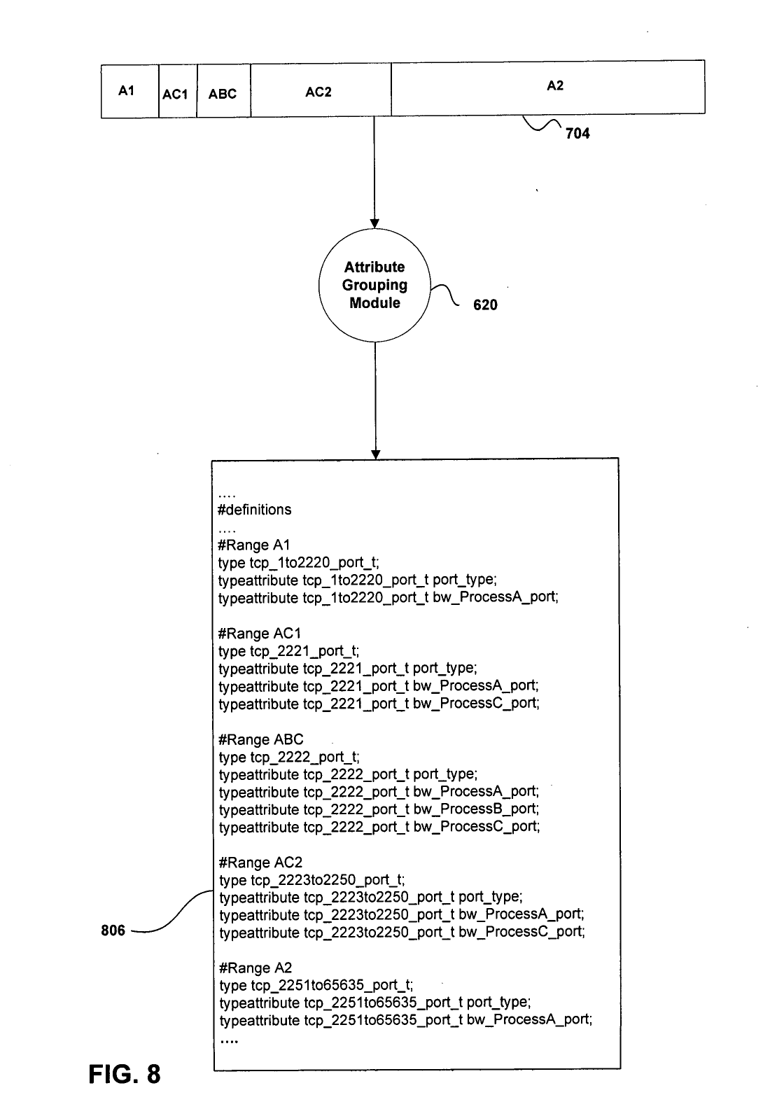

As illustrated in FIG. 8, attribute grouping module 620 receives the non-overlapping ranges 704 and generates definitions 806, which include groups of ranges based on attributes. Definitions 806 include a range A1, a range AC1, range ABC, a range AC2, and a range A2. For range A1, attribute grouping module 620 defines a type corresponding to ports 1 through 2220—namely, tcp_1 to 2220_port_t. Attribute grouping module 620 also adds this type to the attribute “bw_ProcessA_port”, an attribute associated with process A. Process A is the only process that is supposed to communicate on ports 1 through 2220, as specified by the user.

For range AC1, attribute grouping module 620 defines a type corresponding to port 2221—namely, tcp_2221_port_t. Attribute grouping module 620 also adds this type to the attribute “bw_ProcessA_port”. Unlike range A1, however, the type of range AC1 is also added to the “bw_ProcessC_port” attribute, because both process A and process C are supposed to be able to communicate on port 2221, as specified by the user.

In accordance with the user input, and in a similar manner to ranges A1 and AC1, range ABC is associated with process A, process B, and process C. Range AC2 is associated with process A and process C. Range A2 is associated with process A.

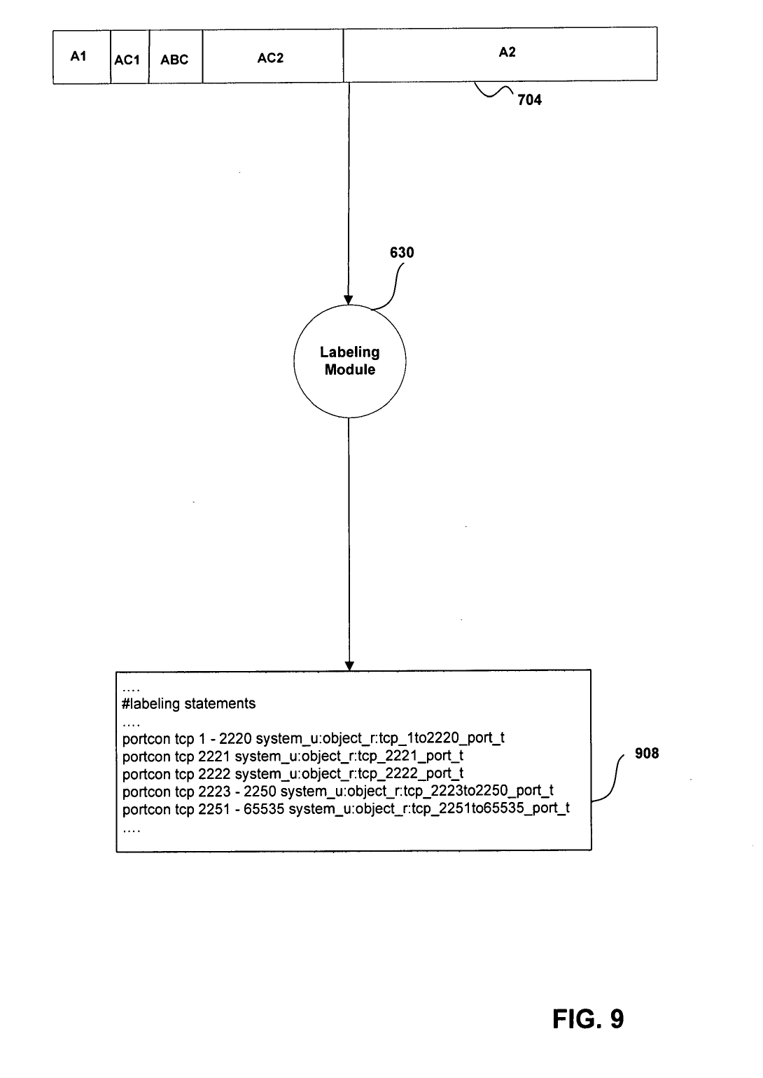

Labeling module 630 generates labeling statements 908 based on the non-overlapping ranges 704 as illustrated, for example, in FIG. 9. Labeling statements 908 associate the types defined in definitions 806 with one or more resources on machine 102, such as ports.

In order to configure the security policy to grant processes A, B, and C access to the ports specified by the user, labeling statements 908 must be loaded into the security policy in the kernel. Linking module 640 may be optionally included in security configuration program 108 to load labeling statements 908 into the security policy.

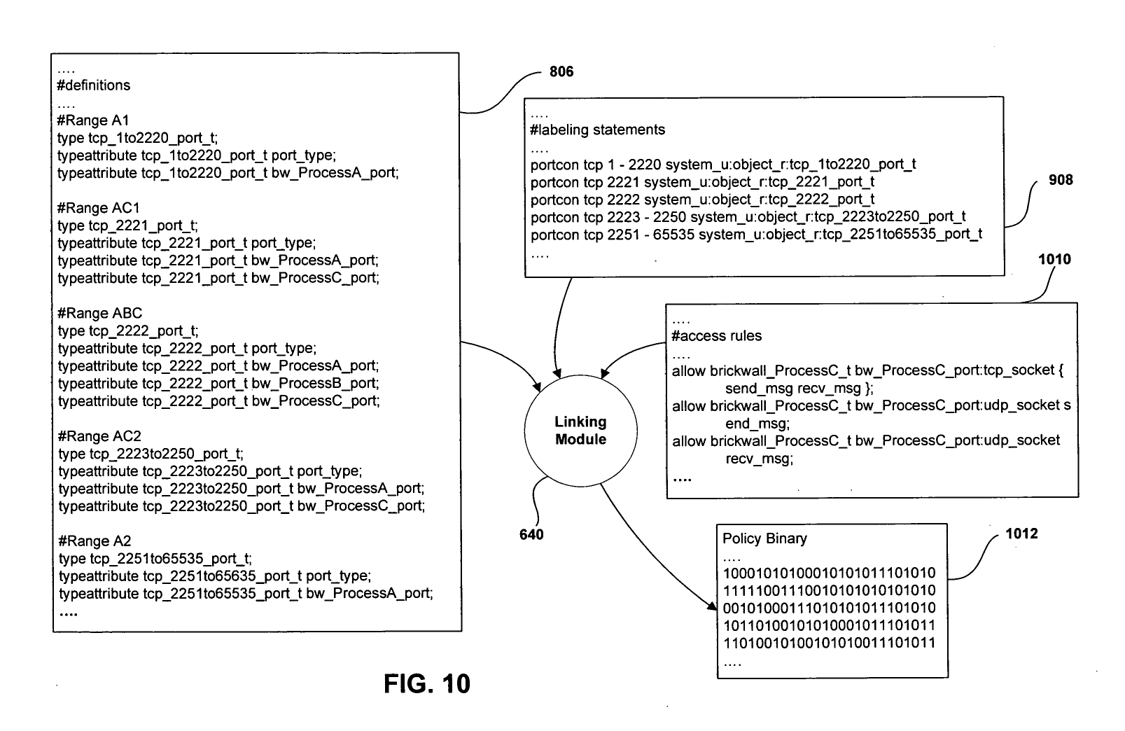

As illustrated in FIG. 10, linking module 640 may generate binary policy 1012 based on definitions 806, labeling statements 908, and access rules 1010. Using linking module 640, the security policy can be configured without requiring a reboot of machine 102. After linking module 640 loads definitions 806 and labeling statements 908 into the security policy in the operating system, processes A, B, and C will have access to the ports specified by the user's input illustrated in FIGS. 2A-B and 5.

As noted above, security configuration program 108 also allows a user to configure the security policy to grant a process access to a specified range of IP addresses. For example, FIGS. 11A-B illustrate a graphical user interface screen shot 1102 and a graphical user interface screen shot 1104. Screen shot 1102 illustrates a range of IP addresses, labeled Range A, with which process A is allowed to communicate. Screen shot 1104 shows that process B should be allowed to communicate with all IP addresses.

Referring to screen shot 1102, Range A is specified to include addresses 192.168.30.0/255.255.255.0. To understand how the numbers 192.168.30.0/255.255.255.0 specify the IP addresses that are to be included in Range A, it is helpful to discuss IP addresses and network masks (“netmasks”).

In Range A, the first set of numbers (namely, 192.168.30.0) is an IP address, and the second set of numbers (namely, 255.255.255.0) is a netmask. Each of these sets of numbers is referred to as a “dotted quad,” and comprises four sets of 8-bit numbers. Thus, each dotted quad comprise 32-bits, which means that an IP address or netmask, when written in binary, comprises a string of thirty-two 1s and 0s. Notably, netmasks always comprise 1s followed by 0s. IP addresses and netmasks are written as dotted quads to make them easier for humans to comprehend.

The IP address 192.168.30.0 specifies the starting IP address in Range A. The netmask 255.255.255.0 is used to determine IP addresses included in Range A. To determine if an IP address is included in Range A, the binary representation of the IP address is ANDed with the binary representation of the netmask. As an example, the IP addresses 192.168.30.4 and 192.168.30.100 are both in Range A because, when ANDed with the binary representation of the netmask 255.255.255.0, the starting IP address is generated, as illustrated in Table 1.

TABLE 1

| | Decimal | Binary | | | |
|---|---|---|---|---|---|
| AND | 192.168.30.4 | 1100 0110 | 1010 1000 | 0001 1110 | 0000 0100 |
| | 255.255.255.0 | 1111 1111 | 1111 1111 | 1111 1111 | 0000 0000 |
| Result | 192.168.30.0 | 1100 0110 | 1010 1000 | 0001 1110 | 0000 0000 |
| AND | 192.168.30.100 | 1100 0110 | 1010 1000 | 0001 1110 | 0110 0100 |
| | 255.255.255.0 | 1111 1111 | 1111 1111 | 1111 1111 | 0000 0000 |
| Result | 192.168.30.0 | 1100 0110 | 1010 1000 | 0001 1110 | 0000 0000 |

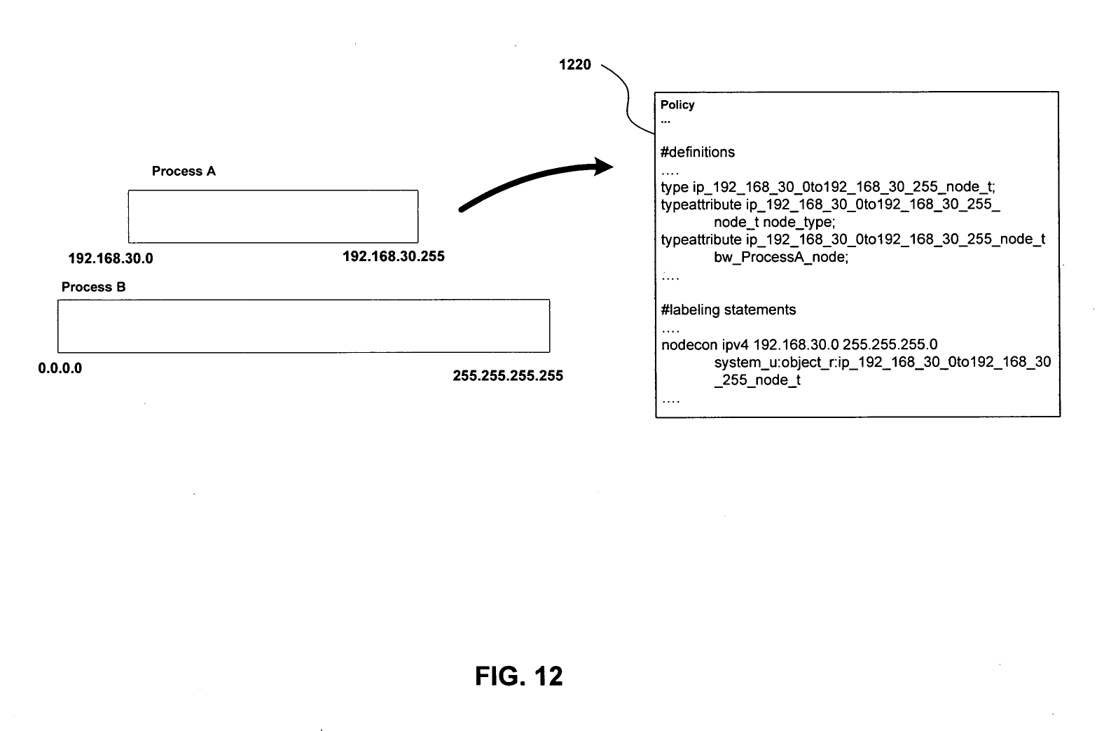

FIG. 12 illustrates the allowed ranges of IP addresses to which process A and process B should be allowed access, and a corresponding policy 1220. Policy 1220 includes definitions and labeling statements. For example, the definitions include a type corresponding to the range of IP addresses 192.168.30.0 through 192.168.30.255. Process A is associated with this type because process A is supposed to have access to IP addresses in this range. The labeling statements associate the types defined in the definitions with the resources of machine 102.

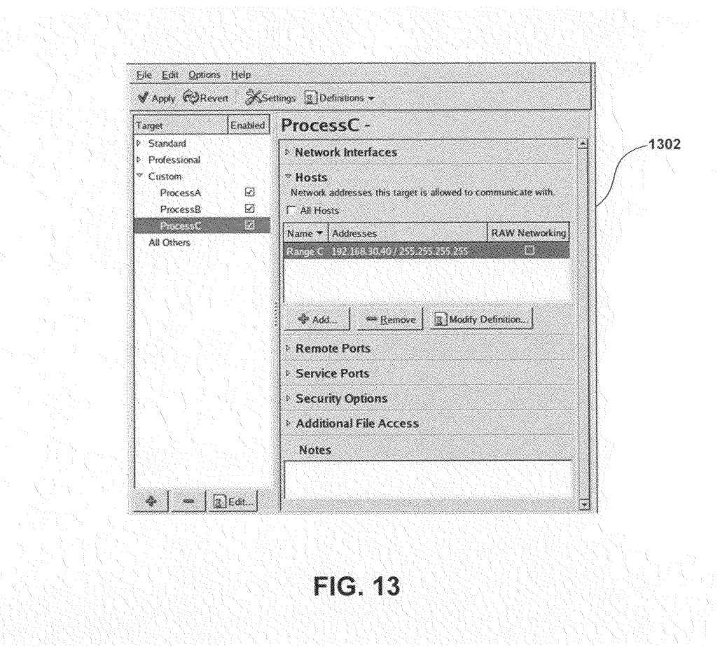

Security configuration program 108 allows a user to configure the IP addresses to which process C should be granted access. For example, FIG. 13 illustrates a graphical user interface screen shot 1302. Screen shot 1302 specifies that process C may communicate with IP addresses starting with 192.168.30.40 and having a netmask of 255.255.255.255. This corresponds to a range that includes only one IP address-192.68.30.40.

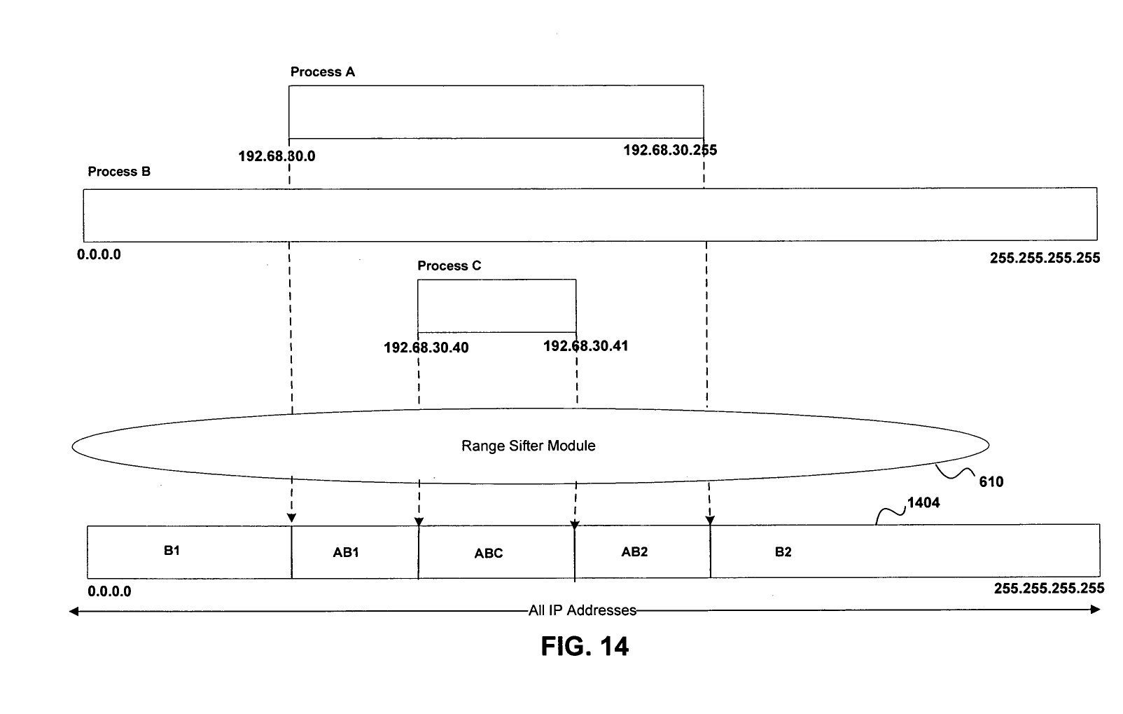

Based on ranges of IP addresses for processes A, B, and C, security configuration program 108 reconfigures the security policy to grant each process access to the specified range of IP addresses. First, range sifter module 610 generates non-overlapping ranges corresponding to the ranges of IP addresses specified by the user. For example, FIG. 14 illustrates the ranges of IP addresses specified for each of processes A, B, and C. Based on these ranges of IP addresses, range sifter module 610 generates non-overlapping ranges 1404. Because a valid netmask always comprises 1s followed by 0s, there are 33 valid netmasks. Each valid netmask can be represented by the number of 1s in it. For example, the octet 255 includes one address, the octet 254 includes two addresses, the octet 252 includes four addresses, and so on. Thus, the number of IP addresses in each non-overlapping range is a power of two.

As illustrated in FIG. 14, non-overlapping ranges 1404 include 5 non-overlapping ranges of IP addresses: (1) a range B1 including IP addresses 0.0.0.0.0 through 192.68.29.255; (2) a range AB1 including IP addresses 192.68.30.0 through 192.68.30.39; (3) a range ABC including IP address 192.68.30.40; (4) a range AB2 including IP addresses 192.68.30.41 through 192.68.30.255, and (5) a range B2 including IP addresses 192.68.31.0 through 255.255.255.255.

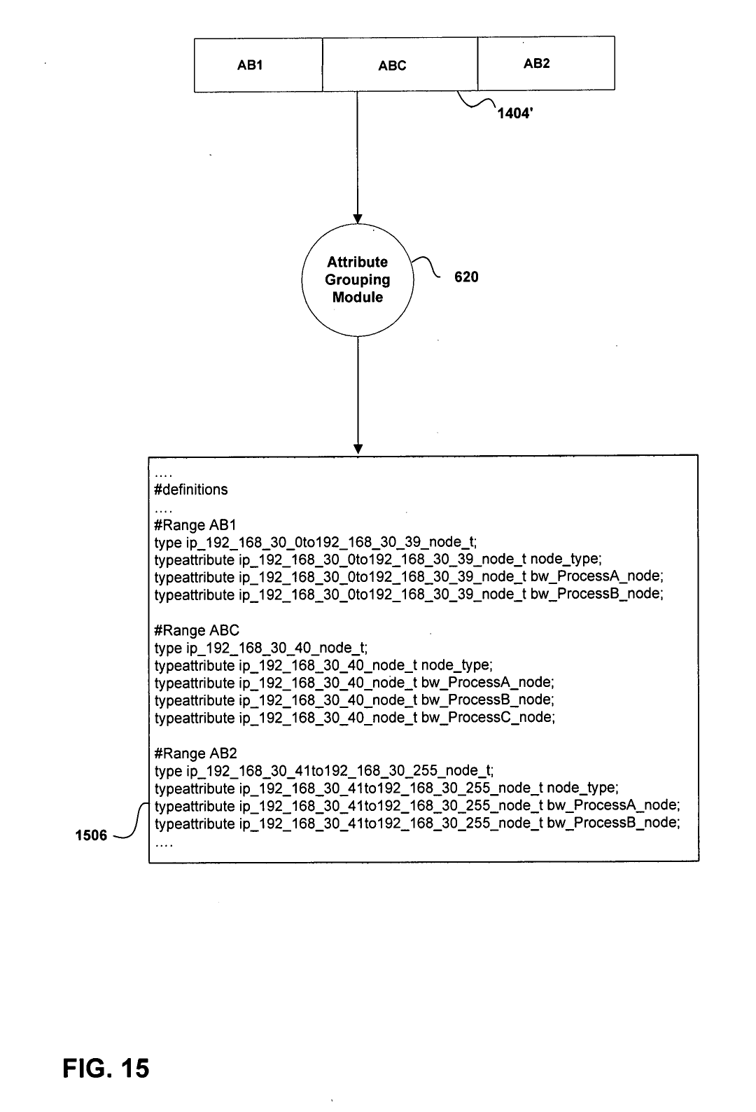

Based on the non-overlapping ranges 1404 of IP addresses, attribute grouping module 620 generates groups of non-overlapping ranges based on attributes. For illustrative purposes, FIG. 15 includes only three of the non-overlapping ranges 1404. In particular, non-overlapping ranges 1404′ of FIG. 15 includes only ranges AB1, ABC, and AB2—the ranges B1 and B2 from FIG. 14 are not included. Based on non-overlapping ranges 1404′, attribute grouping module 620 generates definitions 1506. Definitions 1506 include ranges AB1, ABC, and AB2 grouped based on attributes.

As illustrated in definitions 1506, attribute grouping module 620 defines a type corresponding to range AB1—namely, ip_{—}192_{—}68_{—}30_{—}0to 192_{—}168_{—}30_{—}39_node_t. Attribute grouping module 620 also adds this type to the attributes “bw_ProcessA_node” and “bw_ProcessB_node”, attributes associated with process A and process B, respectively. This is because both process A and process B are supposed to have access to this range of IP addresses in accordance with the user input.

For range ABC, attribute grouping module 620 defines a type corresponding to IP address 192.168.30.40—namely, ip_{—}192_{—}168_{—}30_{—}40_node_t. Attribute grouping module 620 also adds this type to the attributes “bw_ProcessA_node”, “bw_ProcessB_node”, and “bw_ProcessC_node”. Unlike the type of range AB1, attribute grouping module 620 associates the type ip_{—}192_{—}168_{—}30_{—}40_node_t of range ABC with processes A, B, and C because each of these processes is supposed to have access to IP address 192.168.30.40, as specified by the user input.

In accordance with the user input, and in a similar manner to ranges AB1 and ABC, range AB2 is associated with processes A and B.

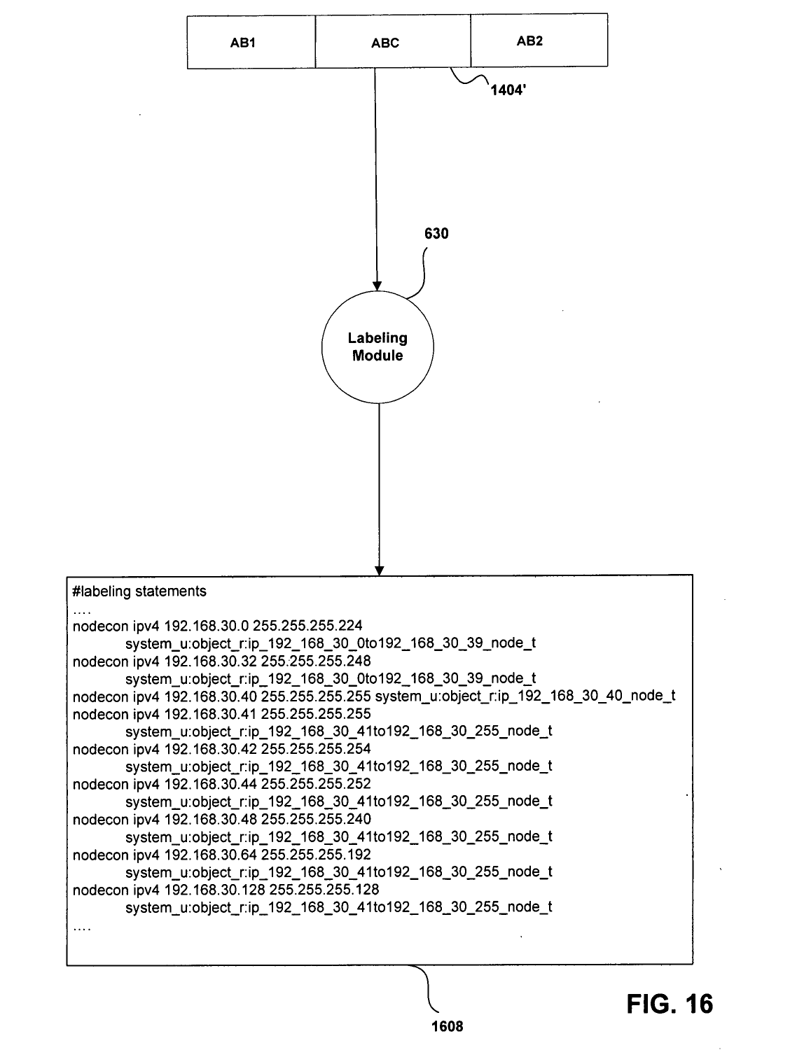

Labeling module 630 generates labeling statements 1608 based on the non-overlapping ranges 1404′ of IP addresses as illustrated in FIG. 16. Similar to labeling statements 908 of FIG. 9, labeling statements 1608 associate the types defined in definitions 1506 with access rules included in the security policy.

Similar to the example illustrated in FIG. 10, linking module 640 can generate policy binary 1712 based on definitions 1506, labeling statements 1608, and access rule 1710 included in the policy on disk. As described herein, security configuration program 108 allows a user to reconfigure the security policy to grant a process access to a specified range of IP addresses. Similar to the example of ports set forth above, the security policy can be reconfigured without requiring a reboot of machine 102.

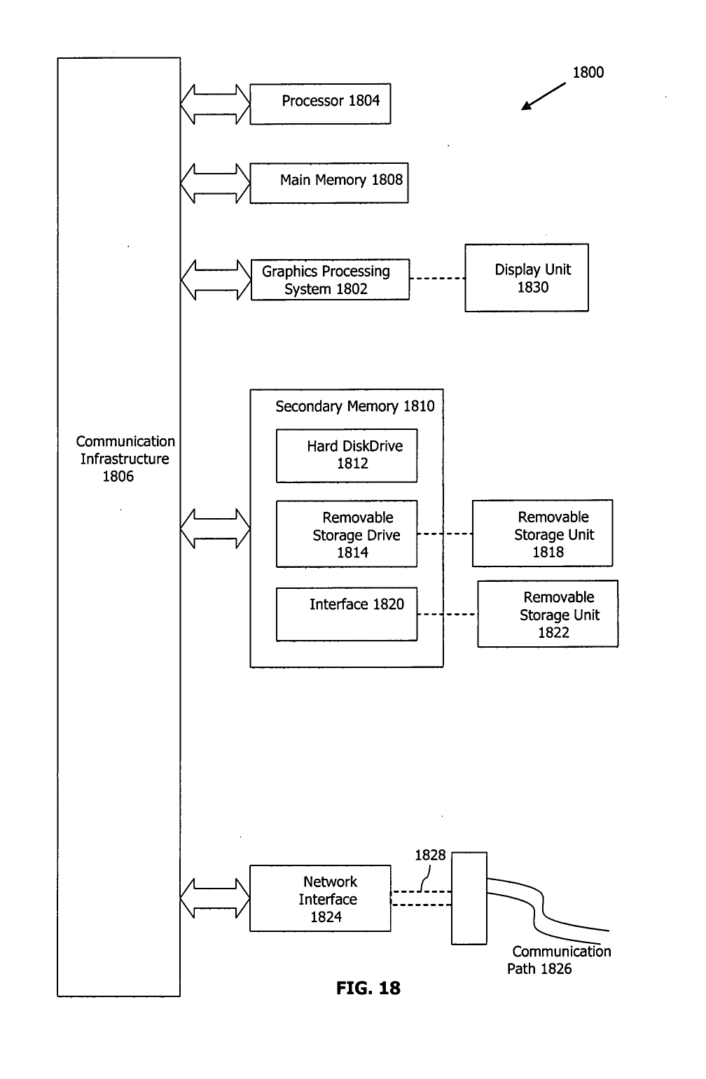

Various aspects of the present invention, such as security configuration program 108, can be implemented by software, firmware, hardware, or a combination thereof. FIG. 18 illustrates an example computer system 1800 in which an embodiment of the present invention, or portions thereof, can be implemented as computer-readable code. Various embodiments of the invention are described in terms of this example computer system 1800. After reading this description, it will become apparent to a person skilled in the relevant art how to implement the invention using other computer systems and/or computer architectures.

Computer system 1800 includes one or more processors, such as processor 1804. Processor 1804 can be a special purpose or a general purpose processor. Processor 1804 is connected to a communication infrastructure 1806 (for example, a bus or network). Computer system 1800 may also include a graphics processing system 1802 for rendering images to an associated display 1830.

Computer system 1800 also includes a main memory 1808, preferably random access memory (RAM), and may also include a secondary memory 1810. Secondary memory 1810 may include, for example, a hard disk drive 1812 and/or a removable storage drive 1814. Removable storage drive 1814 may comprise a floppy disk drive, a magnetic tape drive, an optical disk drive, a flash memory, or the like. The removable storage drive 1814 reads from and/or writes to a removable storage unit 1818 in a well known manner. Removable storage unit 1818 may comprise a floppy disk, magnetic tape, optical disk, etc. which is read by and written to by removable storage drive 1814. As will be appreciated by persons skilled in the relevant art(s), removable storage unit 1818 includes a computer usable storage medium having stored therein computer software and/or data.

In alternative implementations, secondary memory 1810 may include other similar means for allowing computer programs or other instructions to be loaded into computer system 1800. Such means may include, for example, a removable storage unit 1822 and an interface 1820. Examples of such means may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Communications interface 1824 may include a modem, a network interface (such as an Ethernet card), a communications port, a PCMCIA slot and card, or the like. Software and data transferred via communications interface 1824 are in the form of signals 1828 which may be electronic, electromagnetic, optical, or other signals capable of being received by communications interface 1824. These signals 1828 are provided to communications interface 1824 via a communications path 1826. Communications path 1826 carries signals 1828 and may be implemented using wire or cable, fiber optics, a phone line, a cellular phone link, an RF link or other communications channels.

In this document, the terms “computer program medium” and “computer usable medium” are used to generally refer to media such as removable storage unit 1818, removable storage unit 1822, a hard disk installed in hard disk drive 1812, and signals 1828. Computer program medium and computer usable medium can also refer to memories, such as main memory 1808 and secondary memory 1810, which can be memory semiconductors (e.g. DRAMs, etc.). These computer program products are means for providing software to computer system 1800.

Computer programs (also called computer control logic) are stored in main memory 1808 and/or secondary memory 1810. Computer programs may also be received via communications interface 1824. Such computer programs, when executed, enable computer system 1800 to implement embodiments of the present invention as discussed herein, such as security policy generator 700 of FIG. 7. In particular, the computer programs, when executed, enable processor 1804 to implement the processes of embodiments of the present invention. Accordingly, such computer programs represent controllers of the computer system 1800. Where the invention is implemented using software, the software may be stored in a computer program product and loaded into computer system 1800 using removable storage drive 1814, interface 1820, hard drive 1812 or communications interface 1824.

Various systems and methods for implementing mandatory access control in a computer, and applications thereof, have been described in detail herein. It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Furthermore, although aspects of the present invention have been described with reference to SELinux, the invention is not limited to the Linux operating system or SELinux. Based on the description contained herein, a person skilled in the relevant art(s) will appreciate that embodiments of the present invention can be implemented with regard to other operating systems.

What is claimed is:

1. A computer-implemented method for configuring a mandatory access control security policy for a machine that runs programs, wherein the security policy is configured to grant programs access to a resource based on attributes, the method comprising:
(a) receiving ranges of values corresponding to a resource, wherein at least two of the ranges overlap;
(b) generating non-overlapping ranges corresponding to the received ranges for the resource;
(c) grouping the non-overlapping ranges into attributes to which programs are allowed access based on rules contained in the security policy; and
(d) labeling the non-overlapping ranges with labeling statements to allow the security policy to govern access to the resource.

2. The computer-implemented method of claim 1, wherein step (a) comprises receiving the ranges of values from a graphical user interface.

3. The computer-implemented method of claim 1, wherein step (a) comprises receiving ranges of ports, wherein at least two of the ranges of ports overlap.

4. The computer-implemented method of claim 1, wherein step (a) comprises receiving ranges of Internet protocol (IP) addresses, wherein at least two of the ranges of IP addresses overlap.

5. The computer-implemented method of claim 4, wherein step (b) comprises generating non-overlapping ranges of IP addresses corresponding to the received ranges of IP addresses, wherein the number of IP addresses included in each non-overlapping range of IP addresses comprises a power of two.

6. The computer-implemented method of claim 1, further comprising:
(e) loading the grouped non-overlapping ranges and the labeling statements into the security policy.

7. A computer program product comprising a tangible computer-readable storage medium that stores control logic to configure a mandatory access control security policy for a machine that runs programs, the security policy configured to grant programs access to a resource based on attributes, the computer program product receiving ranges of values corresponding to a resource, wherein at least two of the ranges overlap, the control logic comprising:
a range sifting module that generates non-overlapping ranges corresponding to the received ranges for the resource;
an attribute grouping module that groups the non-overlapping ranges into attributes to which programs are allowed access based on rules contained in the security policy; and
a labeling module that generates labeling statements to allow the security policy to govern access to the resource.

8. The computer program product of claim 7, wherein the ranges of values of the resource are received from a graphical user interface.

9. The computer program product of claim 7, wherein the resource comprises ports.

10. The computer program product of claim 7, wherein the resource comprises Internet protocol (IP) addresses.

11. The computer program product of claim 10, wherein each non-overlapping range of IP addresses generated by the range sifting module comprises a power of two.

12. The computer program product of claim 7, further comprising:
a linking module that loads the grouped non-overlapping ranges and the labeling statements into the security policy.

13. A system, comprising:
a network; and
a machine, coupled to the network, that includes a security configuration program adapted to configure a mandatory access control security policy running on the machine based on ranges of values of a resource provided by a user, wherein the security policy is configured to grant access to the resource based on attributes.

14. The system of claim 13, wherein the ranges of values of the resource are received from a graphical user interface.

15. The system of claim 13, wherein the resource comprises ports.

16. The system of claim 13, wherein the resource comprises Internet protocol (IP) addresses.
